(19) United States
(12) Patent Application Publication
(10) Pub. No.: US 2016/0185101 A1
(43) Pub. Date: Jun. 30, 2016

(54) METHOD OF FORMING PATTERN PRINTING LAYER ON NON-ACTIVE AREA OF DISPLAY DEVICE AND DISPLAY DEVICE HAVING THE SAME

(71) Applicant: T3i Co., Ltd., Suwon-si (KR)

(72) Inventors: Manhwa Lee, Seoul (KR); Hee Do Park, Hwaseong-si (KR)

(21) Appl. No.: 14/673,924

(22) Filed: Mar. 31, 2015

(30) Foreign Application Priority Data
Dec. 31, 2014 (KR) 10-2014-0195887

(51) Int. Cl. B41F 15/00; B41J 2/01

(52) U.S. Cl. CPC B41F 15/00; B41J 2/01

(57) ABSTRACT

Provided is a method of printing a pattern on a non-active area of a display device. The method includes (a) performing an inkjet printing process on a foreground color layer and (b) performing a screen-printing process on a background color layer. In the method of printing the decoration pattern on the not-active area of the display device according to the present invention, the foreground color layer with respect to the decoration pattern of the display device may be printed in the inkjet manner to simply easily uniformly realize the high resolution image having the high quality of color.

### CROSS-REFERENCE TO RELATED PATENT APPLICATION

This application claims the benefit of Korean Patent Application No. 10-2014-0195887, filed on Dec. 31, 2014, in the Korean Intellectual Property Office, the disclosure of which is incorporated herein in its entirety by reference.

### BACKGROUND OF THE INVENTION

1. Field of the Invention

The present invention relates to a method of printing a decorative pattern on a display device, and more particularly, to a method of forming a pattern printing layer on a non-active area, i.e. non-viewing or non-displaying area of a display device and a display device having the same.

2. Description of the Related Art

Recently, an attempt for realizing various design characteristics of a product is actively in progress by printing a decorative element such as a color or surface pattern having a light-shield function on a certain area of a transparent window substrate such as cover glass or glass for a touch screen, which is defining an outer surface of a display device that constitutes a monitor, a TV, or a smartphone, particularly, on a non-active area on which an image is not displayed so as to prevent leakage light from being transmitted and to prevent circuit wire patterns of display from being seen and recognized from the outside. According to the related art, the method of realizing the light-shield function and printing the color or pattern on the transparent window substrate is generally performed as follows: chemical or thermal strengthening treatment is performed on glass on which routing and hole processing is completed; and a simple screen-printing method is performed on a non-active area of the backside of the corresponding transparent window substrate by using predetermined ink. The screen-printing ink (stencil paste) includes a composition having a paste phase in which silicone acrylate, epoxy, and acrylic-based binder, organic or inorganic pigment, and dispersant are added into a solvent.

According to the simple screen-printing method that is performed on the non-active area of the transparent window substrate, a fabric or metal wire mesh screen mask is attached to a metal frame, and light sensitizing emulsion such as photoresist is applied onto the mesh screen. Then, the emulsion coating layer is dried, and a film having a pattern is closely attached to the dried screen. Thereafter, exposure and developing processes are performed on the emulsion layer to make designated openings of screen, which correspond to pattern of the screen mask.

In detail, the screen mask with metal frame is mounted on an upper portion of a screen-printing device, and the transparent window substrate is aligned with a lower portion of the screen mask to match the pattern of the screen mask. Then, the screen mask descends and is closely attached to the substrate. Then, the stencil paste is applied on the screen mask, and a corresponding squeegee moves at predetermined speed in one direction while applying a predetermined pressure to the substrate by using the squeegee. As a result, the pattern of the screen mask may be transferred to the substrate in a manner in which the stencil paste is applied onto the non-active area of the transparent window substrate through an opening of the screen mask. The screen mask is separated, and then the substrate is generally dried at a temperature of about 200° C. to remove the solvent and cure the binder, thereby finishing the unit screen-printing process.

The unit screen-printing process may be performed several times according to kinds and usage of transparent window substrates. For example, a black or white foreground color layer is printed first on a back surface of the transparent window substrate with a thickness of about 5 μm to about 30 μm. Then, to protect the foreground color layer or increase light shieldability, a light shield layer is additionally printed on a bottom surface of the foreground color layer. If necessary, a frame layer having a thin solid line shape is printed on a boundary between a foreground color-patterned portion and other portions (portions such as the active area of the display, a camera lens hole, a proximity sensor hole, an icon area, a logo type, and the like). Also, if necessary, an anti-reflection layer may be printed on the inside of the camera lens hole, and an infrared ray filter layer may be printed on the inside of the proximity sensor hole. Also, a separate pattern layer may be printed on each of the icon part and the logo part. Thus, five to ten color screen-printing may be generally performed on the transparent window substrate according to the kinds and usage of substrates.

If the foreground color layer is printed on the non-active area of the transparent window substrate in the screen-printing manner, there is a limitation in that a precise high resolution image is realized. For example, a screen mask for screen-printing is manufactured in a network shape which is a pattern assembly having fine point images and is divided into CMYK 4 colors to perform four color printing. However, it is substantially impossible to precisely align the points having several micrometers while the transparent window substrate is four-color printed. Also, the spots of the network may be connected to each other during the screen-printing, and thus printing quality is deteriorated. Thus, there is a limitation in that various and high resolution decoration patterns are realized on the transparent window substrate.

Since there are above-described limitations in decoration pattern printing in the screen-printing method according to the related art, pearl-colored pigment is added into the stencil paste to realize various decoration effects, or expensive and complicated method is adopted, for example, three-dimensional texture such as hair line metallic pattern is expressed through an etching or an resin coating with imprinting and multiple thin film deposition process, and then the foreground color is printed in the screen-printing manner. However, various high resolution images may not be clearly realized. Also, in case of the simple screen-printing method, expressiveness with respect to the color may be changed according to composition and viscosity of printing ink, or a thickness and uniformity of a painted film, and thus process and working conditions have to be strictly controlled.

### SUMMARY OF THE INVENTION

The present invention provides a method of forming a pattern printing layer with respect to a non-active area of a display device, which is capable of simply realizing a high resolution image having high quality colors with low costs, and of remarkably developing colors of the pattern, and of easily realizing various colors similar to a metal color and a display device having the same.

The recognition with respect to the above-described limitations and the substances of the present invention with respect to solutions based on the recognition will be described as follows.

(1) A method of printing a pattern on a non-active area of a display device includes: (a) performing an inkjet printing process on a foreground color layer; and (b) performing a screen-printing process on a background color layer.

(2) The performing of the screen-printing process on the background color layer may be performed twice or more.

(3) The background color layer may have a white color, a silver color, or a combination thereof.

(4) The background color layer may have a silver color, and the background color layer may be adjusted in metal color texture by controlling at least one of a color, density, or a size of a pixel of the foreground color layer.

(5) The background color layer may consist of a first layer having a silver color and a second layer having a white color.

(6) A display device includes: a foreground color layer formed in an inkjet printing manner; and a background color layer formed in a screen-printing manner on a back surface of the foreground color layer.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating a structure of a pattern printing layer of a display device according to an embodiment of the present invention;

FIGS. 2 to 5 are structure views of a printing layer to which a background color layer of the pattern printing layer is applied according to an embodiment of the present invention; and

FIG. 6 is an exemplary picture of a decoration pattern depending on a color control according to an embodiment of the present invention.

### DETAILED DESCRIPTION OF THE INVENTION

Exemplary embodiments of the present invention will be described below in more detail with reference to the accompanying drawings. Like reference numerals in the drawings denote like elements.

Furthermore, when it is described that one comprises (or includes or has) some elements, it should be understood that it may comprise (or include or has) only those elements, or it may comprise (or include or have) other elements as well as those elements if there is no specific limitation.

Also, when it is described that one element is selectively provided, disposed, or included, it should be understood that it may not be essentially adopted, but be randomly adopted in regards to the solutions of the present invention.

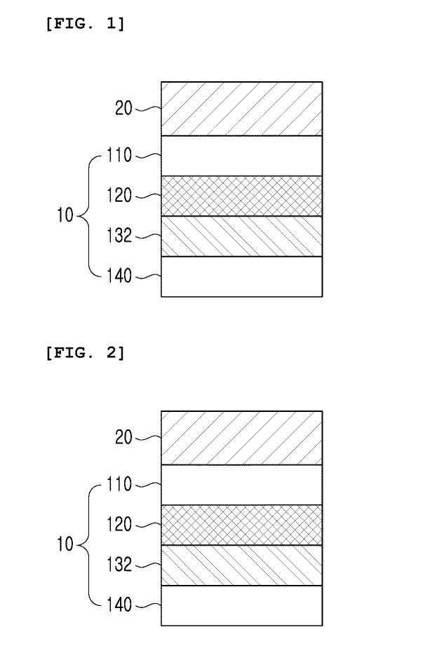

FIG. 1 is a structure view of printing layers with respect to a non-active area of a display device according to an embodiment of the present invention. A method of printing a design pattern with respect to the non-active area of the display device (hereinafter, referred to as a “design printing method”) according to the present invention is performed in a manner in which printing layers are successively formed according to FIG. 1.

FIG. 1 is a structure view of a printing layer on a non-active area of a display device according to an embodiment of the present invention. A method of printing a pattern on the non-active area of the display device (hereinafter, referred to as a “pattern printing method”) according to the present invention is performed in a manner in which printing layers are successively formed according to FIG. 1.

Referring to FIG. 1, a printing layer 10 disposed inside a substrate 2 includes a first screen-printing layer 110, a foreground color layer 120, a background color layer 130, and a second screen-printing layer 140.

The first and second screen-printing layers 110 and 140 may be selectively formed according to kinds and usage of display substrates to which the pattern printing method is applied according to the present invention. For example, the first screen-printing layer 110 may print at least one of a logo or an IR layer in a screen-printing manner. The second screen-printing layer 140 may print at least one of a shield layer, the IR layer, a wire electrode layer in the screen-printing manner.

In the pattern printing method according to the present invention, the foreground color layer 120 is realized in an inkjet printing manner to realize a high resolution image having a high quality color instead of a manner in which the typical screen-printing is performed several times.

A thickness of the foreground color layer 120 formed in the inkjet printing manner may be principally controlled by adjusting a size of a discharged ink droplet, viscosity of ink, or a contact angle with the substrate. However, since ink having low viscosity of about 5 cP or less has to be used to stably discharge the ink, the foreground color layer 120 may have a thickness of about 1 μm or less.

According to the present invention, the foreground color layer 120 may be printed in the inkjet printing manner, particularly, in a digital inkjet printing manner to realize a high quality color (i.e., to improve accuracy of the color). That is, since a detailed value with respect to each of colors of a printing output is measured by using a spectrophotometer to write an ICC profile, and the ICC profile is inputted into a printer driver software, an RIP software, or the like to directly apply the ICC profile, color correction with respect to am output color of the foreground layer may be precisely performed in real time. Also, the detailed value may be periodically measured to correct the color during the printing process and to fundamentally prevent deviation in printing quality from occurring according to ink management or complicated process condition management in the screen-printing process according to the related art, thereby easily improving accuracy and quality of the color.

Also, according to the inkjet printing manner with respect to the foreground color layer 120, a high resolution color image, which is difficult to be realized by the typical screen-printing manner even though screen mask division printing is performed at least four times, may be realized by performing the inkjet printing only once.

In the inkjet printing with respect to the foreground color layer 120, heat-resistant water pigment ink containing cyan, magenta, yellow, black, light cyan, light magenta, white pigments may be used. Here, well-mixed ink having low viscosity of about 10 cP or less, preferably viscosity of about 5 cP or less may be used so as to jet ink and prevent a passage (i.e., a path up to an ink storage chamber, a tube path, cartridge, and an inkjet head nozzle part) from being blocked.

In this case, a waterborne acrylate resin having excellent heat resistance may be added as a binder contained in the ink so that the ink for foreground color layer 120 surrounds and applies the pigment to adhere to glass.

Also, the ink for printing the foreground color layer 120 may be quickly dried and cured to improve printing quality. In detail, if the ink droplet is discharged from a nozzle in the inkjet head to form a pixel on a display substrate formed of a glass material, the ink may not be absorbed into the display substrate formed of the glass material unlike a paper and thus be spread at a moment in which the ink drops. Thus, the pixel may increase in size or be connected to peripheral pixels to deteriorate printing quality. Therefore, in order to prevent the above phenomenon, the discharged ink droplet may be quickly dried and cured to minimize a phenomenon in which the droplet increases in size. To quickly dry and cure the ink droplet, moisture or an organic solvent contained in the ink has to be quickly volatilized and dried, and simultaneously, the binder contained in the ink has to be quickly cured to allow the pigment to be firmly attached to the display substrate. Thus, if necessary, a heat generation device may be disposed on a lower portion of a printing bed of an inkjet printing machine, or a unit that is capable of increasing a temperature of the display substrate at a predetermined temperature may be provided.

The inkjet printing process with respect to the foreground color layer 120 may be realized as an additional process with respect to the existing printing process to reduce costs and improve productivity. For example, in the case of the existing pattern printing method, the screen-printing method may be simply adopted several times. Here, if the method according to the present invention is applied to the existing process line, only the foreground color layer printing process may be replaced with the inkjet printing manner in the screen-printing process without significantly changing the existing screen-printing process line.

In the pattern printing method according to the present invention, a separate printing process may be performed on the background color layer 130 after the inkjet printing process on the foreground color layer 120. The background color layer 130 may be provided to improve color development of the foreground color layer 120 by the inkjet printing and to lead the pixel of the foreground color layer 120 to be mixed to realize various colors similar to a metal color.

A color development effect with respect to the foreground color layer 120 may be realized by forming a white background color layer 130, and various colors similar to the metal color may be realized by forming a silver background color layer 130.

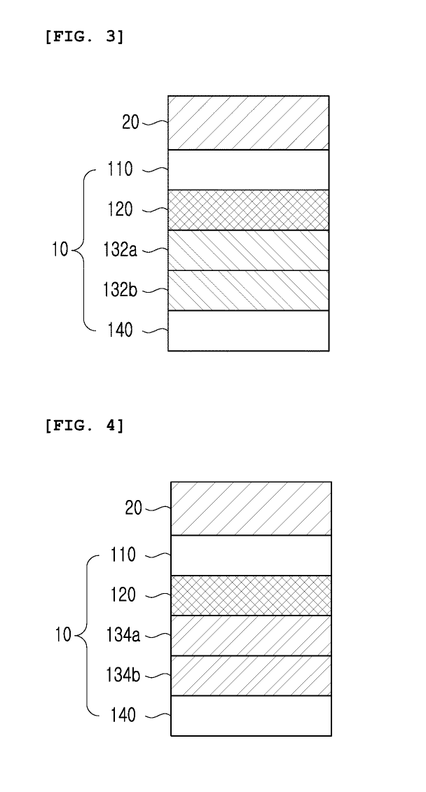

In this case, the background color layer 130 may be selected from the white color, the silver color, or a combination thereof as illustrated in FIGS. 2 to 5. Also, the white or silver color may be formed in a single layer or two or more layers.

In FIG. 2, an example in which a single layered silver background color layer 132 is formed to realize various colors similar to the metal color. In this case, various colors realized by mixing the silver background color layer 132 with the foreground color layer 120 may be achieved by controlling at least one of color, density, or size of the pixel of the foreground color layer 120 by the inkjet printing.

For example, when the pixel of the foreground color layer 120 decreases in density by the inkjet printing, a large number of metal color characteristics may be developed. On the contrary, when the pixel increases in density, metal texture may be reduced, and a color of the foreground color layer 120 itself may be more developed. Also, when the pixel of the foreground color layer 120 decreases in size, the pixel density may be reduced to increase the metal texture. On the contrary, the pixel increases in size, the metal texture may be reduced.

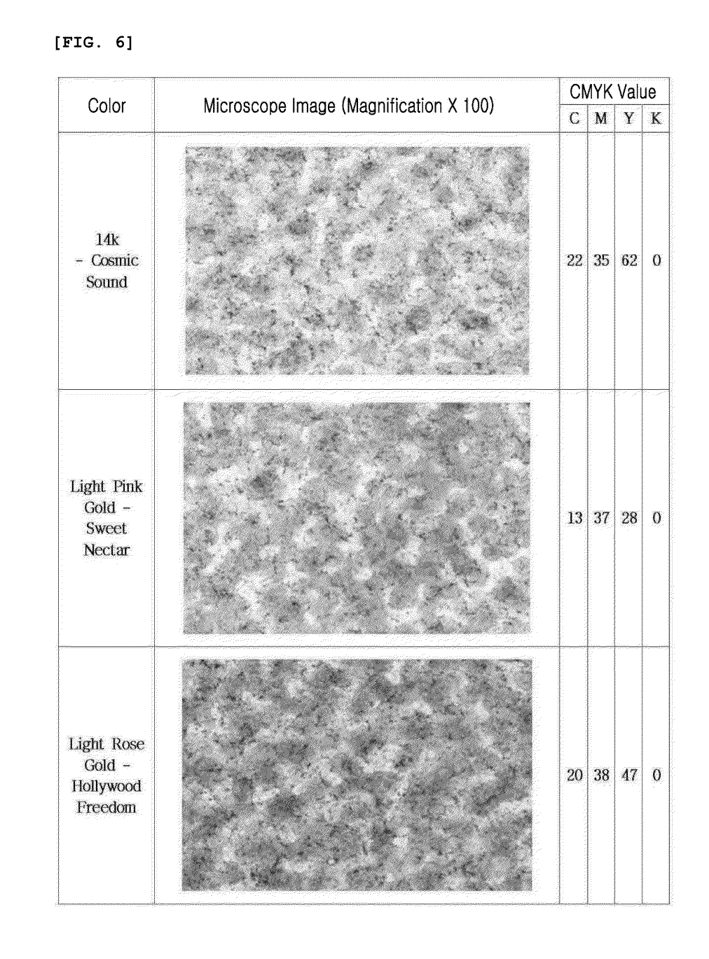

Also, the foreground color layer 120 may be controlled in color to develop a color having various tones by being mixed with the silver background color layer 132. For example, when the foreground color layer 120 has a yellow-based color, various tones of gold color may be developed according to a degree of a yellow color. Also, when the foreground color layer 120 has a red-based color, a pink gold or bronze gold color may be developed according to a degree of a red color. Also, when the foreground color layer has a blue-based color, a bluish gold-based color may be developed. When the color of the foreground color layer is divided, and a graphic image such as a repeated pattern or character is printed on a portion or the whole of the foreground color layer, a decoration pattern having a metal color in which a fine pattern and an image co-exists may be realized. FIG. 6 shows an exemplary picture showing a design pattern developed through color control according to an embodiment of the present invention. The ink used in the foreground color layer 120 printing may be controlled in a CMYK color value to develop various gold-based decoration patterns.

FIG. 3 illustrates an example in which double layered silver background color layers 132a and 132b are formed. Typically, since the silver background color layer has a structure in which aluminum flakes are stacked, and light passes through the silver background color layer when a gap between particles exists, the silver background color layers 132a and 132b are provided as double layers in FIG. 3 to more efficiently develop the metal texture. Also, if necessary, the silver background color layers 132a and 132b may be provided as multi layers in addition to an embodiment of FIG. 3.

FIG. 4 illustrates an example in which two-layered white background color layers 134a and 134b are provided. As described above, the white background color layers 134a and 134b may be basically formed to improve clearness of the color that is expressed to the foreground color layer 120. That is, the foreground color layer 120 formed in the inkjet printing manner may be deteriorated in color clearness by light transmission due to a thin film thickness of about 1 μm thereof. Here, to prevent the above-described limitation, the white background color layers 134a and 134b may be formed. Also, the white background color layer may be realized in double or multi layers in a case in which the deterioration in color clearness due to the light transmission is not sufficiently prevented by the single layered white background color layer. However, although it is expected that the single layered white background color layer has a sufficient thickness, when the ink increases in viscosity, workability is reduced. Also, when a screen mask having a low network number (i.e., a screen mask having a thick screen mesh line) is used for the screen-printing to increase a thickness of the film, an edge of the screen mask may be reduced in resolution to deteriorate printing quality.

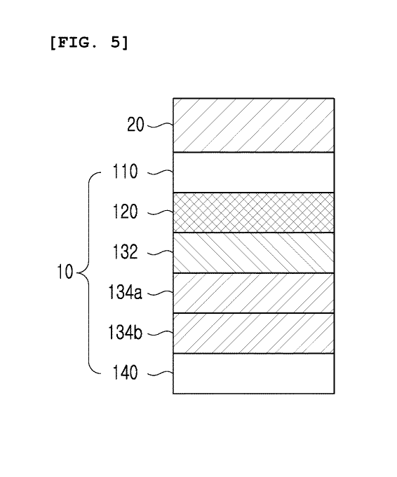

FIG. 5 illustrates an example in which background color layers 132, 134a, and 134b are provided with a silver first layer and a white second layer. This is an example in which a color development effect with respect to the foreground color layer 120 and various colors similar to the metal color are realized at the same time.

The printing with respect to the background color layer 130 may be performed by using a stainless still wire screen of about 300 mesh to about 500 mesh in the screen printing manner. The white background color layer may be formed with a thickness of about 3 to about 30 μm, and the silver background color layer may be formed with a thickness of about 1 to about 5 μm. The background color layer 130 may be formed as double or multi layers to increase shieldability.

As the white ink used for printing the background color layer 130, a stencil paste having middle/high viscosity in which white pigment such as tin oxide (TiO2), acrylate, epoxy, urethane, and silicone acrylate resin-based binder, an organic solvent, and an additive such as a dispersion agent are contained may be used. As the silver ink, silver mirror paste ink having middle/high viscosity that is suitable for screen printing may be used. The silver mirror paste ink may be constituted by leafing or non-leafing aluminum flake pigment, the resin binder, an organic solvent, and an additive. Also, a flake according to a deposition manner may be used to increase reflectability of the aluminum flake.

In the method of printing the decoration pattern on the not-active area of the display device according to the present invention, the foreground color layer with respect to the decoration pattern of the display device may be printed in the inkjet manner to simply easily uniformly realize the high resolution image having the high quality of color. The process of printing the foreground color layer may be realized as the additional process with respect to the existing printing process to reduce the costs and improve the productivity.

Also, after the foreground color layer with respect to the decoration pattern is printed in the inkjet manner, the white or silver background color may be printed on the top surface of the inkjet printing layer in the silk-screen manner to significantly improve the color development with respect to the pattern by the inkjet printing layer and to lead the network point of the inkjet printing layer to be mixed in color, thereby realizing various colors similar to the metal color.

While the present invention has been particularly shown and described with reference to exemplary embodiments thereof, it will be understood by those of ordinary skill in the art that various changes in form and details may be made therein without departing from the spirit and scope of the present invention as defined by the following claims. Thus, it will be understood by those of ordinary skill in the art that all the preferred various changes and modifications can be made and equivalents employed, without departing from the present invention.

What is claimed is:

1. A method of printing a pattern on a non-active area of a display device, the method comprising:
(a) performing an inkjet printing process on a foreground color layer; and
(b) performing a screen-printing process on a background color layer.

2. The method of claim 1, wherein the performing of the screen-printing process on the background color layer is performed twice or more.

3. The method of claim 1, wherein the background color layer has a white color, a silver color, or a combination thereof.

4. The method of claim 1, wherein the background color layer has a silver color, and the background color layer is adjusted in metal color texture by controlling at least one of a color, density, or a size of a pixel of the foreground color layer.

5. The method of claim 1, wherein the background color layer consists of a first layer having a silver color and a second layer having a white color.

6. A display device comprising:
a foreground color layer formed in an inkjet printing manner; and
a background color layer formed in a screen-printing manner on a back surface of the foreground color layer.
